(19) United States
(12) Patent Application Publication
(10) Pub. No.: US 2009/0190158 A1
(43) Pub. Date: Jul. 30, 2009

(54) METHOD FOR SAVING PRINTER PAPER

(75) Inventor: Meena Sundararajan, Austin, TX (US)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/021,285

(22) Filed: Jan. 28, 2008

(51) Int. Cl. G06F 3/12

(52) U.S. Cl. 358/1.15

(57) ABSTRACT

A method for saving paper on a printer, including: providing a user interface that includes a buffer option window on the print window for storing, in a buffer that is located in a directory that can be chosen by a user, a plurality of separate documents to be printed without having to open a new window and without having to change print properties; a user clicking on the buffer option window of the user interface to store in the buffer a first document to be printed; the user clicking on the buffer option window of the user interface at least once more to store in the buffer at least a second document to be printed; and the user clicking on the buffer option window of the user interface to print the first document and at least the second document, along with only a single title page.

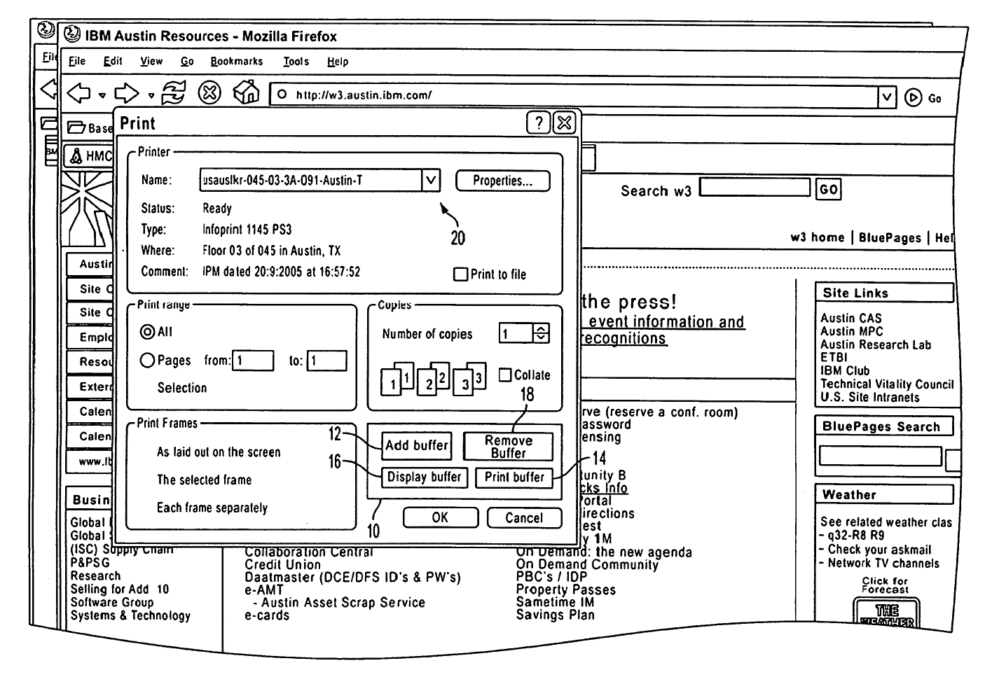

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to a method of saving paper on a printer.

(2) Description of Related Art Including Information Submitted Under 37 CFR 1.97 and 1.98

In an office environment, printing multiple different documents at the same time can waste a lot of title pages and thus a lot of paper. For example, if there are ten different one page documents that are to be printed at the same time, issuing printing ten times can take up ten title pages.

The term “title page” is defined herein to refer to the first page that is printed with details such as “Title, Date printed, Submitted by, Printer information” and the like.

Pages 628-629 of the April 2002 Research Disclosure (RD Number 456) include a disclosure of a method and user interface for user-controlled printing in a network computing environment. The RD discloses that when a print command is executed, users can select ‘immediate printing’ or ‘buffered printing’ in the print property page. When ‘buffered printing’ is selected, users can manipulate printing jobs in a new ‘buffered printing manager’ window.

Uchida et al. (U.S. Pat. No. 7,227,655) discloses utilizing otherwise unused space on cover or partition sheets printed in response to a print command.

Kujirai et al. (U.S. Patent No. 2007/0294532 discloses a print control apparatus and print system in which a plurality of jobs is authenticated as a single job.

### BRIEF SUMMARY OF THE INVENTION

This disclosure is directed to a method for saving paper on a printer.

In particular, the disclosure is directed to a method for saving paper on a printer, including: providing a user interface that includes a buffer option window on the print window for storing, in a buffer that is located in a directory that can be chosen by a user, a plurality of separate documents to be printed without having to open a new window and without having to change print properties; a user clicking on the buffer option window of the user interface to store in the buffer a first document to be printed; the user clicking on the buffer option window of the user interface at least once more to store in the buffer at least a second document to be printed; and the user clicking on the buffer option window of the user interface to print the first document and at least the second document, along with only a single title page.

Other exemplary embodiments and advantages of this disclosure can be ascertained by reviewing the present disclosure and the accompanying drawings.

### BRIEF DESCRIPTION OF THE SEVERAL VIEWS OF THE DRAWING(S)

This disclosure is further described in the detailed description that follows, with reference to the drawing, in which: the FIGURE shows an embodiment of a user interface in accordance with at least some aspects of this disclosure.

### DETAILED DESCRIPTION OF THE INVENTION

Exemplary embodiments of this disclosure are described herein by way of example.

As discussed above, printing multiple different documents at the same time can waste a lot of title pages and thus a lot of paper. It is possible to manually copy each of the document contents that are to be printed to a separate file/document and then issue a print, so that all the information then contained in the separate file/document is printed in one print job and with just one title page.

However, the need to manually waste time creating a new page and adding all details to that page can be avoided by creating one title page, thus saving on paper.

When multiple documents or web pages or any other applications need to be printed at one time, a general method is to print the first document (“document A”) and then the next document (“document B”) and then the next document (“document C”) and so on.

A printer ends up printing document A with a title page, and document B with another title page, and document C with another title page. Although all of the documents are being printed at the same time, the user can end up wasting many title pages, since they are printed separately.

This disclosure is directed to an option, referred to herein as a “buffer” box or window, such as buffer box 10 as shown in the FIGURE, on the print window 20. The user thus has an option of adding all of the pages that the user wants to be printed at the same point In time to a buffer utilizing the buffer box 10.

The buffer can append data as and when they are added. Thus, when it is desired to print documents A, B, and C at the same time, the user can open document A, and on the print window 20 add document A to the buffer. Then the user can move on to document B and, on the print window, add document B to the buffer. Then the user can switch to document C, and on the print window, add document C to the buffer.

There can be a window on the print window to, for example, “PRINT BUFFER” 14 (or “PRINT BUFFER DATA”) that, if clicked, will print on a printer all of the data currently in the buffer.

Thus, after adding the three documents to the buffer, the user can click on “PRINT BUFFER” 14 resulting in a printer printing all three documents A, B, and C at one time with only one title page.

There can also be an option to “CLEAR BUFFER” 18, which will remove from the buffer all of the data added to the buffer.

There can also be a window to “DISPLAY BUFFER” 16 to show the data that is currently stored in the buffer.

In contrast to the RD document (pages 628-629 of the April 2002 Research Disclosure Number 456), a user does not have to go to the print property page nor open a new ‘buffered printing manager’ window.

The buffer can be a temporary storage area that continues to append information that is added to the buffer. This temporary storage area can be located in, for example C:\tmp, or an option can be provided for the user to choose where they would like to have the buffer located.

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A method for saving paper on a printer, comprising:
providing a user interface that includes a buffer option window on the print window for storing, in a buffer that is located in a directory that can be chosen by a user, a plurality of separate documents to be printed without having to open a new window and without having to change print properties;
a user clicking on the buffer option window of the user interface to store in the buffer a first document to be printed;
the user clicking on the buffer option window of the user interface at least once more to store in the buffer at least a second document to be printed; and
the user clicking on the buffer option window of the user interface to print the first document and at least the second document, along with only a single title page.
